(19) United States
(12) Patent Application Publication
(10) Pub. No.: US 2015/0240059 A1
(43) Pub. Date: Aug. 27, 2015

(54) Method of Producing Rubber Compositions with Reinforcing Resins

(71) Applicant: Xiaofeng Shaw Yang, Simpsonville, SC (US)

(72) Inventor: Xiaofeng Shaw Yang, Simpsonville, SC (US)

(73) Assignee: Michelin Recherche et Technique S.A., Granges-Paccot (CH)

(21) Appl. No.: 14/427,231

(22) PCT Filed: Sep. 10, 2012
(86) PCT No.: PCT/US12/54369

§ 371 Date: Mar. 10, 2015

(51) Int. Cl. C08L 7/00; C08L 9/06

(52) U.S. Cl. CPC C08L 7/00; C08L 9/06; C08L 2205/03

(57) ABSTRACT

Methods for producing a rubber composition for a tire component that include preparing a methylene acceptor block by mixing a first highly unsaturated diene elastomer with a methylene acceptor. This mixture is then cooled and may then be used or may be stored for later use in producing a rubber composition. Such methods may further include mixing a non- productive mix, the non-productive mix comprising a second highly unsaturated diene elastomer, a reinforcing filler and the methylene acceptor block. The methylene acceptor block itself comprises no or essentially no reinforcing filler. To prepare for the addition of the vulcanization agent, such methods, include cooling the non-productive mix and then mixing a vulcanizing agent and a methylene donor into the cooled non-productive mix to produce a productive mix.

### BACKGROUND OF THE INVENTION

1. Field of the Invention

This invention relates generally to rubber compositions and more specifically, to methods of producing a rubber composition.

2. Description of the Related Art

Tires and other articles that are made of rubber are manufactured from rubber compositions that include rubber, e.g., natural rubber, synthetic rubber or combinations thereof, as well as fillers, plasticizers, vulcanizing agents and other chemicals that improve the physical characteristics of the cured rubber composition. One class of materials that may be added to the rubber compositions is resin.

Resins are typically (but not always) nonvolatile, solid organic substances that are produced naturally by plants or synthetically from petrochemicals or other sources of hydrocarbon materials. As used in rubber compositions, resins may be classified as either reinforcing resins or as plasticizing resins. Plasticizing resins are added to a rubber composition to improve the plasticity or workability of a rubber composition. They are often added as a substitute for or in addition with a processing oil and are known to improve the resulting physical characteristics of the cured rubber composition.

Reinforcing resins are added to a rubber composition to increase the rigidity of the cured rubber composition. These reinforcing resins intermix with the rubber polymer chains and, when reacted with a linking agent or with each other, form a three-dimensional network that improves the physical characteristics of the cured rubber composition. Examples of the use of such reinforcing resins may be found, for example, in U.S. Patent Application Publications 2005/0222318 and 2008/0271831.

### SUMMARY OF THE INVENTION

Particular embodiments of the present invention include methods for producing a rubber composition for a tire component. Such methods include preparing a methylene acceptor block by mixing a first highly unsaturated diene elastomer with a methylene acceptor. This mixture is then cooled and may then be used in producing a rubber composition or stored for later use in producing a rubber composition.

Such methods may further include mixing a non-productive mix, the non-productive mix comprising a second highly unsaturated diene elastomer, a reinforcing filler and the methylene acceptor block. In particular embodiments, the methylene acceptor block itself comprises no or essentially no reinforcing filler.

To prepare for the addition of the vulcanization agent, such methods include cooling the non-productive mix and then mixing a vulcanizing agent and a methylene donor into the cooled non-productive mix to produce a productive mix.

The foregoing and other objects, features and advantages of the invention will be apparent from the following more detailed descriptions of particular embodiments of the invention.

### DETAILED DESCRIPTION OF PARTICULAR EMBODIMENTS

Particular embodiments of the present invention include methods for producing rubber compositions that have organic reinforcing resins in them. Typically such rubber compositions have fairly high rigidity and are useful for the manufacture of tire components where high rigidity properties are often desired, such as in the bead area, e.g., the apex, bead filler and chafer, and in the tire tread, including retread rubber useful for retreading a tire.

Surprisingly it has been discovered that by preparing such rubber composition by methods that include mixing a methylene acceptor block into a non-productive mix, the rigidity of the resulting cured rubber composition and the processability of the uncured composition are significantly improved. It is noted that the term “methylene acceptor block”, as used herein, is defined as a rubber composition that includes a methylene acceptor and contains no or essentially no reinforcing filler. In the disclosed method, the methylene acceptor bloc is mixed into a non-productive mix to produce a rubber composition suitable for forming into a useful article for curing.

As used herein, “diene elastomer” and “rubber” are synonymous terms and may be used interchangeably.

As used herein, a “non-productive” mix includes many of the components of a rubber composition but includes no vulcanization agents or primary accelerators. A “productive” mix results after the vulcanization agents and any primary accelerators are added to the non-productive mix.

The quantities of components added to the rubber compositions disclosed herein are expressed in terms of parts by weight of the component per hundred parts by weight of the rubber in the rubber composition, which is commonly expressed as parts per hundred parts of rubber, phr.

Reference will now be made in detail to embodiments of the invention, provided by way of explanation of the invention. For example, features illustrated or described as part of one embodiment can be used with another embodiment to yield still a third embodiment. It is intended that the present invention include these and other modifications and variations.

Organic reinforcing resins are well known in the tire industry and their use in rubber compositions is known to increase the cured rubber composition's rigidity. Suitable organic reinforcing resins include methylene acceptor/donor systems that react together to generate a three-dimensional reinforcing resin network by a condensation reaction. In particular embodiments of the disclosed method, the methylene acceptor is mixed into the methylene acceptor block which is later mixed into the non-productive mix and the methylene donor, or resin crosslinking agent, is mixed into the productive mixture with the vulcanization agents.

Suitable methylene acceptors include phenols, the generic name for hydroxylated derivatives of benzene and equivalent compounds. This definition covers in particular monophenols, for example phenol or hydroxyhenzene, bisphenols, polyphenols (polyhydrpxyarenes), substituted phenols such as alkylphenols or aralkylphenols, for example bisphenols, diphenylolpropane, diphenylolmethane, naphthols, cresol, t-butylphenol, octylphenol, nonylphenol, xylenol, resorcinol or analogous products.

Suitable methylene donors may be selected from, for example, hexamethylenetetramine (HMT); hexamethoxymethylmelamine (HMMM); formaldehyde; paraformaldehyde; trioxane; 2-methyl-2-nitro-1-propanal; substituted melamine resins such as N-substituted oxymethylmelamine resist; glycoluril compounds such as tetramethoxymethyl glycoluril; urea-formaldheyde resins such as butylated urea-formaldheyde resins; or mixtures thereof. Hexamethylenetetramine (HMT), hexamethoxymethylmelamine (HMMM) or mixtures thereof are preferred methylene donors in particular embodiments.

Phenolic resins of the type known as “Novolac resins” are useful as methylene acceptors in particular embodiments of the methods disclosed herein. Novolac resins are phenol-aldehyde pre-condensates resulting from the condensation of phenolic compounds and aldehydes, in particular formaldehyde. These Novolac resins (also referred to as “two-step resins”) require the use of a methylene donor as a curing agent to crosslink the Novolac resins in the rubber composition, thereby creating the three dimensional resin networks. Such curing takes place around 90° C.

Novolac resins differ from resol resins, which are also phenol-aldehyde pre-condensate resins, in that resol resins have a higher formaldehyde to phenol ratio and are a one-step process. In the one-step process, resols crosslink upon heating (at about 120° C.) and do not need the addition of a methylene donor to cure in a “second step.” Novolacs, after cross-linking by the methylene donor, are characterized in particular by a tighter three-dimensional lattice than the three dimensional network formed by the resols.

In particular embodiments the methylene acceptor may be present in the rubber compositions in an amount of between 2 phr and 30 phr or alternatively between 5 phr and 25 phr, 10 phr and 30 phr or between 10 phr and 20 phr. The methylene donor may be present in the rubber composition as needed to provide the desired cross-linking in an amount, for example, of between 8 wt. % and 80 wt. % of the total weight of methylene acceptor in the rubber composition, or alternatively between 10 wt. % and 60 wt. %, between 10 wt. % and 40 wt. % or between 15 wt. % and 35 wt. %.

Particular embodiments of the methods disclosed herein include the use of any methylene donor/methylene acceptor system suitable for use with a given rubber composition including systems having one or more methylene acceptors and one or more methylene donors.

The useful elastomers of the rubber composition that may be produced with the methods disclosed herein include highly unsaturated diene elastomers. Diene elastomers or rubber is understood to mean those elastomers resulting at least in part (i.e., a homopolymer or a copolymer) from diene monomers (monomers bearing two double carbon-carbon bonds, whether conjugated or not). Essentially unsaturated diene elastomers are understood to mean those diene elastomers that result at least in part from conjugated diene monomers, having a content of members or units of diene origin (conjugated dienes) that are greater than 15 mol. %.

Thus, for example, diene elastomers such as butyl rubbers, nitrite rubbers or copolymers of dienes and of alpha-olefins of the ethylene-propylene, diene terpolymer (EPDM) type or the ethylene-vinyl acetate copolymer type, do not fall within the preceding definition and may in particular be described as “essentially saturated” diene elastomers (how or very low content of units of diene origin, i.e., less than 15 mol. %). Particular embodiments of the present invention include no essentially saturated diene elastomers.

Within the category of essentially unsaturated diene elastomers are the highly unsaturated diene elastomers, which are understood to mean in particular diene elastomers having a content of units of diene origin (conjugated dienes) that is greater than 50 mol. %. Particular embodiments of the present invention may include not only no essentially saturated diene elastomers but also no essentially unsaturated diene elastomers that are not highly unsaturated.

The rubber elastomers suitable for use with particular embodiments of the present invention include highly unsaturated diene elastomers, for example, polybutadienes (BR), polyisoprenes (IR), natural rubber (NR), butadiene copolymers, isoprene copolymers and mixtures of these elastomers. The polyisoprenes include synthetic cis-1,4 polyisoprene, which may be characterized as possessing cis-1,4 bonds at more than 90 mol. % or alternatively, at more than 98 mol. %.

Also suitable for use in particular embodiments of the present invention are rubber elastomers that are copolymers and include, for example, butadiene-styrene copolymers (SBR), butadiene-isoprene copolymers (BIR), isoprene-styrene copolymers (SIR) and isoprene-butadiene-styrene copolymers (SBIR) and mixtures thereof.

It should be noted that any of the highly unsaturated elastomers may be utilized in particular embodiments as a functionalized elastomer. Elastomers can be functionalized by reacting them with suitable functionalizing agents prior to or in lieu of terminating the elastomer. Exemplary functionalizing agents include, but are not limited to, metal halides, metalloid halides, alkoxysilanes, imine-containing compounds, esters, ester-carboxylate metal complexes, alkyl ester carboxylate metal complexes, aldehydes or ketones, amides, isocyanates, isothiocyanates, imines, and epoxides. These types of functionalized elastomers are known to those of ordinary skill in the art. While particular embodiments may include one or more of these functionalized elastomers solely as the rubber component, other embodiments may include one or more of these functionalized elastomers mixed with one or more of the non-functionalized highly unsaturated elastomers.

In addition to the rubber component and the organic reinforcing resin, reinforcing filler are included in the rubber compositions produced in accordance with the methods disclosed herein. However, as noted previously, the reinforcing filler is not mixed into the methylene acceptor block, the methylene acceptor block being essentially free of any reinforcing filler in accordance with the methods disclosed herein. Instead the reinforcing filler is mixed into the non-productive mix.

Reinforcing fillers are well known in the art and include, for example, carbon blacks and silica. Any reinforcing filler known to those skilled in the art may be used in the rubber composition either by themselves or in combination with other reinforcing fillers. In particular embodiments of the methods disclosed herein, the filler mixed into the non-productive mix is essentially a carbon black.

Carbon black, which is an organic filler, is well known to those having ordinary skill in the rubber compounding field. The carbon black included in the rubber compositions produced by the methods disclosed herein may, in particular embodiments for example, be in an amount of between 40 phr and 150 phr or alternatively between 50 phr and 100 phr.

Suitable carbon blacks are any carbon blacks known in the art and suitable for the given purpose. Suitable carbon blacks of the type HAF, ISAF and SAF, for example, are conventionally used in tire treads. Non-limitative examples of carbon blacks include, for example, the N115, N134, N234, N299, N326, N330, N339, N343, N347, N375 and the 600 series of carbon blacks, including, but not limited to N630, N650 and N660 carbon blacks.

As noted above, silica may also be useful as reinforcement filler. The silica may be any reinforcing silica known to one having ordinary skill in the art including, for example, any precipitated or pyrogenic silica having a BET surface area and a specific CTAB surface area both of which are less than 450 m²/g or alternatively, between 30 and 400 m²/g may be suitable for particular embodiments based on the desired properties of the cured rubber composition. Particular embodiments of rubber compositions produced by the methods disclosed herein may include a silica having a CTAB of between 80 and 200 m²/g, between 100 and 190 m²/g, between 120 and 190 m²/g or between 140 and 180 m²/g. The CTAB specific surface area is the external surface area determined in accordance with Standard AFNOR-NFT-45007 of November 1987.

Highly dispersible precipitated silicas (referred to as “HDS”) may be useful in particular embodiments of such rubber compositions produced by the methods disclosed herein, wherein “highly dispersible silica” is understood to mean any silica having a substantial ability to disagglomerate and to disperse in an elastomeric matrix. Such determinations may be observed in known manner by electron or optical microscopy on thin sections. Examples of known highly dispersible silicas include, for example, Perkasil KS 430 from Akzo, the silica BV3380 from Degussa, the silicas Zeosil 1165 MP and 1115 MP from Rhodia, the silica Hi-Sil 2000 from PPG and the silicas Zeopol 8741 or 8745 from Huber.

When silica is added to the rubber composition, a proportional amount of a silane coupling agent is also added to the rubber composition. The silane coupling agent is a sulfur-containing organosilicon compound that reacts with the silanol groups of the silica during mixing and with the elastomers during vulcanization to provide improved properties of the cured rubber composition. A suitable coupling agent is one that is capable of establishing a sufficient chemical and/or physical bond between the inorganic filler and the diene elastomer; which is at least bifunctional, having, for example, the simplified general formula “Y-T-X”, in which: Y represents a functional group (“Y” function) which is capable of bonding physically and/or chemically with the inorganic filler, such a bond being able to be established, for example, between a silicon atom of the coupling agent and the surface hydroxyl (OH) groups of the inorganic filler (for example, surface silanols in the case of silica); X represents a functional group (“X” function) which is capable of bonding physically and/or chemically with the diene elastomer, for example by means of a sulfur atom; T represents a divalent organic group making it possible to link Y and X.

Any of the organosilicon compounds that contain sulfur and are known to one having ordinary skill in the art are useful for practicing embodiments of the present invention. Examples of suitable silane coupling agents having two atoms of silicon in the silane molecule include 3,3′-bis(triethoxysilylpropyl) disulfide and 3,3′-bis(triethoxy-silylpropyl) tetrasulfide (known as Si69). Both of these are available commercially from Degussa as X75-S and X50-S respectively, though not in pure form. Degussa reports the molecular weight of the X50-S to be 532 g/mole and the X75-S to be 486 g/mole. Both of these commercially available products include the active component mixed 50-50 by weight with a N330 carbon black. Other examples of suitable silane coupling agents having two atoms of silicon in the silane molecule include 2,2′-bis(triethoxysilylethyel) tetrasulfide, 3,3′-bis(tri-t-butoxy-silylpropyl) disulfide and 3,3′-bis(di-t-butylmethoxysilylpropyl) tetrasulfide. Examples of silane coupling agents having just one silicon atom in the silane molecule include, for example, 3,3′(trethoxysilylpropyl) disulfide and 3,3′ (triethoxy-silylpropyl) tetrasulfide. The amount of silane coupling agent can vary over a suitable range as known to one having ordinary skill in the art. Typically the amount added is between 7 wt. % and 15 wt. % or alternatively between 8 wt. % and 12 wt. % or between 9 wt. % and 11 wt. % of the total weight of silica added to the rubber composition.

Particular embodiments of the rubber compositions produced with the methods disclosed herein may include no processing oil or very little, such no more than 5 phr. Processing oils are well known to one having ordinary skill in the art, are generally extracted from petroleum and are classified as being paraffinic, aromatic or naphthenic type processing oil, including MES and TDAE oils. Some of the rubber composition so produced may include an elastomer, such as a styrene-butadiene rubber, that has been extended with one or more such processing oils but such oil is limited in the rubber composition as being no more than 10 phr of the total elastomer content of the rubber composition.

The rubber compositions suitable for being produced by the methods disclosed herein may further include, in addition to the compounds already described, all or part of the components often used in diene rubber compositions intended for the manufacture of tires, such as plasticizers, pigments, protective agents of the type that include antioxidants and/or antiozonauts, vulcanization retarders, a vulcanization system based, for example, on sulfur or on a peroxide, vulcanization accelerators, vulcanization activators, extender oils and so forth. There may also be added, if desired, one or more conventional non-reinforcing fillers such as clays, bentonite, talc, chalk or kaolin.

The vulcanization system is preferably one based on sulfur and on an accelerator. Use may be made of any compound capable of acting as accelerator of the vulcanization of elastomers in the presence of sulfur, in particular those chosen from the group consisting of 2-mercaptobenzothiazyl disulfide (abbreviated to “MBTS”), N-cyclohexyl-2-benzothiazolesulphenamide (abbreviated to “CBS”), N,N-dicyclohexyl-2-benzothiazolesulphenamide (abbreviated to “TBBS”), N-tert-butyl-2-benzothiazolesulphenamide (abbreviated to “TBSI”), N-tert-butl-2-benzothiazolesulphenimide (abbreviated to “TBSI”) and the mixtures of these compounds. Preferably, a primary accelerator of the sulfenamide type is used.

Additional to this vulcanization system are various known secondary accelerators or vulcanization activators, such as zinc oxide, stearic acid and guanidine derivatives (in particular diphenylguanidine).

As noted previously, the methods disclosed herein for producing a rubber composition having an organic reinforcing resin include preparing a methylene acceptor block that may be later added to a non-productive mix. The methylene acceptor block may be prepared by mixing a first highly unsaturated diene elastomer with a methylene acceptor. In particular embodiments, the methylene acceptor in the methylene acceptor block may include one or more different types of methylene acceptors and the first highly unsaturated diene elastomer may include one or more different such elastomers.

The-methylene acceptor may be mixed into the first highly unsaturated diene elastomer in an amount not limited by the invention and as may be suitable for a given application. For example, in particular embodiments of the methods disclosed herein the amount of methylene acceptor in the block may be between 5 phr and 200 phr or alternatively, between 30 phr and 200 phr, between 30 phr and 150 phr, between 50 phr and 120 phr or at least 50 phr of the methylene acceptor.

While particular embodiments of these methods limit the methylene acceptor block to comprising just the highly unsaturated elastomer and the methylene acceptor, other embodiments may include additional components in the methylene acceptor block such as one or more of vulcanizing activators (e.g., stearic acid, zinc oxide), secondary vulcanization accelerators (e.g., guanidine derivatives) and/or process aids (e.g., plasticizing oil, paraffin). The components that should not be added to the methylene acceptor block include vulcanizing agents (e.g., sulfur), primary vulcanization accelerators and methylene donors.

Carbon black and other reinforcing fillers should not be added to the methylene acceptor block. Particular embodiments of the methods disclosed herein provide for adding no carbon black or other such fillers to the methylene acceptor block or alternatively, essentially no such fillers, wherein essentially no such fillers, if a definition is required, may be no more than about 5 phr of a reinforcing filler, preferably no more than 2 phr or no more than 1 phr.

One issue to consider when adding other materials to the methylene acceptor block is that the ratio of the additional materials to the rubber in the block may not provide the necessary quantity in the non-productive mix after adding the methylene acceptor block in the quantity necessary to provide the required methylene acceptor quantity.

Mixing the highly unsaturated diene elastomer and the methylene acceptor includes adding these materials and optionally any additional materials to a mixer, such as an internal mixer of the Banbury type or other suitable mixer, and mixing the materials until they are well incorporated. In particular embodiments, the method includes adding the highly unsaturated diene elastomer to the mixer and working the material for a period until it is softened and then adding the methylene acceptor to the mixer either all at once or in fractions of, for example, halves or thirds. Other components, if added, may be added to the mixer in the same manner.

Typically, for particular embodiments, the components may be well incorporated when the temperature reaches around 60° C. or around 70° C. or after a suitable time as known by those having ordinary skill in the art. After the materials are well incorporated, the method may further include dropping the methylene acceptor block material from the mixer and cooling it to at least 40° C. or alternatively to at least 35° C. or to at least 30° C. The cooling may be provided by milling the material on a two-roll mill, wherein optionally the mill rolls may be cooled to provide quicker cooling. Without limiting the invention, it is thought that the cooling step helps ensure that the methylene acceptor particles are well surrounded and protected by the highly unsaturated diene elastomer chains so that when the methylene acceptor block is later mixed, into the non-productive mix containing the reinforcing filler, e.g., carbon black, the methylene acceptor will not absorb/adsorb or otherwise interact with the carbon black particles.

After the methylene acceptor block has been cooled, particular embodiments of the method may further include storing the methylene acceptor block for a period until needed for mixing into a non-productive mix or may include transferring the methylene acceptor block to an internal mixer for mixing into a non-productive mix.

In the step of mixing a non-productive mix, the non-productive mix comprises a second highly unsaturated diene elastomer, the reinforcing filler and the methylene acceptor block. The second highly unsaturated diene elastomer may be the same or different than the first highly unsaturated diene elastomer used in the production of the methylene acceptor block. Other components that may be optionally added to the non-productive mix include the vulcanization activators, secondary vulcanization accelerators, anti-degradation additives, pigments, non-reinforcing fillers and so forth.

Surprisingly, all of the methylene acceptor does not have to be added to the non-productive mix in the form of the methylene acceptor block. At least a portion of the methylene acceptor may be added directly to the mix without a significant lessening of the favorable results. In particular embodiments, up to 60 wt. % of the methylene acceptor (based on the total weight of the methylene acceptor in the rubber composition) or alternatively up to 50 wt. %, up to 25 wt. % or up to 10 wt. % of the methylene acceptor may be added directly to the non-productive mix without being first mixed into a methylene acceptor block, i.e., premixed into an elastomer mixture.

In particular embodiments having additional methylene acceptor added to the non-productive mix without its first being premixed into and elastomer mixture, the additional methylene acceptor may be of the same type as that mixed in with a block or it may be of a different type.

Mixing the non-productive mix includes adding the components of the non-productive mix to a mixer, such as an internal mixer of the Banbury type, and mixing the materials until they are well incorporated. The components may all be added at the same time or at different times during the mixing process. For example, in particular embodiments, the methylene acceptor block may be added to the mixer after the reinforcing filler has been at least partially dispersed throughout the elastomer.

The non-productive mix is processed by mixing the components in the mixer until all the components are well incorporated, i.e., well dispersed throughout the highly unsaturated diene elastomer. Knowledge of mixing such non-productive mixes is well known in the art and one having ordinary skill in the art can determine when the mixing step is complete (all the components are well incorporated) based inter alia, on the temperature of the mix and/or the length of mixing time. Such times and temperatures are based upon the types and efficiencies of the mixers as well as the types of highly unsaturated diene elastomers and the amounts of fillers and-other components that are incorporated into the non-productive mix.

Upon determining that the mixing of the non-productive mix is complete, the methods include dropping or removing the non-productive mix from the mixer and further include cooling the non-productive mix to a temperature that is suitable for adding the vulcanization agent and the methylene donor. Cooler temperatures are required for mixing the productive mix, as known to those skilled in the art, to prevent scorch, the onset of premature curing or the reaction between the methylene donor and methylene acceptor.

The method further includes adding and mixing the methylene donor into the productive mix either at the same time as the vulcanization agent and the primary accelerator is added or at a different time. Other components that were not added into the nonproductive mixture may optionally be mixed into the productive mix such as vulcanization activators and/or secondary vulcanization accelerators. The step of cooling the non-productive mix and of adding or mixing the methylene donor into the productive mix may be accomplished on any suitable apparatus, such as a two-roll mill that may be, for example, water cooled.

After the rubber composition is fully mixed, the methods may further include forming the rubber composition into a tire component and curing it. The tire component may be cured with the tire if incorporated into an uncured tire or it may be cured separately from the tire curing if incorporated into a cured tire, as in the case of a retread formed by embodiments of the methods disclosed herein and bonded to a buffed tire carcass. Such forming may include, for example, extruding the rubber composition to form a tire tread.

The invention is further illustrated by the following examples, which are to be regarded only as illustrations and not delimitative of the invention in any way. The properties of the compositions disclosed in the examples were evaluated as described below.

Mooney Plasticity (ML 1+4) was measured in accordance with ASTM Standard D1646. In general, the composition in an uncured state is molded in a cylindrical enclosure and heated to 100° C. After 1 minute of preheating, the rotor turns within the test sample at 2 rpm, and the torque used for maintaining this movement is measured after 4 minutes of rotation. The Mooney Plasticity is expressed in “Mooney units” (MU, with 1 MU=0.83 Newton-meter).

Scorch was measured in accordance with ASTM Standard D 1646 at 130° C. In general, Mooney scorch is reported as the time required for the viscosity to rise a set number of Mooney units above the minimum viscosity at the measured temperature.

Moduli of elongation (MPa) were measured at 10% (MA10) at a temperature of 23° C. based on ASTM Standard D412 on dumb bell test pieces. The measurements were taken in the second elongation; i.e., alter an accommodation cycle. These measurements are secant moduli in MPa, based on the-original cross section of the test piece.

Hysteresis losses (HL) were measured in percent by rebound at 60° C. at the sixth impact in accordance with the following equation:

HL(%)=100(W₀−W₁)/W₁,

where W₀ is the energy supplied and W1 is the energy restored.

The elongation property was measured as elongation at break (%) and the corresponding elongation stress (MPa), which is measured at 23° C. in accordance with ASTM Standard D412 on ASTM C test pieces.

Processability was measured by a subjective standard of the observer wherein poor processability occurred when the mixture could not be dropped from the Banbury mixer or with the occurrence of significant sticking of the mixture to the rotor. The more easily the mixture was dumped from the Banbury mixer, the higher the better the processability rating.

### Example 1

This example illustrates a method for preparing a methylene acceptor block containing rubber and a methylene acceptor. The methylene acceptor was a Novolac reinforcing resin that was mixed with the rubber to prepare the methylene acceptor blocks in the amounts shown in Table 1.

TABLE 1
Methylene Acceptor Block Formulations

| | B1 | B2 | B3 |
|---|---|---|---|
| NR | 100 | | |
| SBR | | 100 | 100 |
| Methylene Acceptor | 50 | 50 | 100 |
| Zinc Oxide | | | 100 |

Each of the methylene acceptor blocks were mixed with the rubber components shown in Table 1 with the third methylene acceptor block B3 further mixed with 100 phr of zinc oxide to demonstrate that other materials may be mixed into the methylene acceptor block as long as they are not the reinforcing filler or the vulcanizing agent, such as sulfur.

To mix the methylene acceptor blocks, the elastomer was introduced into the Banbury mixer and mixed until softened; then half of the Novolac was introduced into the mixer. After the temperature of the mixer reached 50° C., the other half of the Novolac was added and the mixing continued until the temperature reached 60° C. The mixture was then dropped out of the mixer and milled for ten minutes on a two-roll mill.

For the B3 formulation, tire zinc oxide was added in halves at the same time each half of the Novolac was added to the mixture. However, instead of dropping the mixture from the mixer at 60° C.,. the mixture was dropped from the mixer at 70° C. before being milled on the two-roll mill for ten minutes.

### Example 2

This example illustrates a method for mixing a rubber composition using the methylene acceptor block prepared in Example 1. The formulations were prepared with the component amounts shown in Table 2.

The additives included 6PPD, paraffin and vulcanization promoter. The vulcanization package included insoluble sulfur and vulcanization accelerator.

TABLE 2
Formulations Using the Methylene Acceptor Blocks from Example 1

| | W1 | F1 | F2 | F3 |
|---|---|---|---|---|
| Components | | | | |
| NR | 50 | 40 | 50 | 50 |
| SBR | 50 | 50 | 40 | 45 |
| Carbon Black, N326 | 50 | 50 | 50 | 50 |
| Novolac | 5 | | | |
| Methylene Acceptor Block B1 | | 15 | | |
| Methylene Acceptor Block B2 | | | 15 | |
| Methylene Aceentor Block B3 | | | | 15 |
| Zinc Oxide | 5 | 5 | 5 | |
| Additives | 6 | 6 | 6 | 6 |
| Vulcanization Pkg. | 3 | 3 | 3 | 3 |
| Hexamethylenetetramine | 1.67 | 1.67 | 1.67 | 1.67 |
| Uncured Properties | | | | |
| Mooney (1 + 4) at 100° C. | 68.3 | 67.0 | 68.0 | 68.9 |
| Scorch @ 130° C., minutes | 9.0 | 9.4 | 9.1 | 9.0 |
| Processability | Poor | Good | Very Good | Very |
| | | | | Good |
| Cured Properties | | | | |
| MA10, MPa | 8.0 | 8.3 | 8.0 | 8.3 |
| P60, % | 26.8 | 27.0 | 26.8 | 27.1 |
| Elongation Stress, MPa | 17 | 18 | 15 | 16 |
| Elongation at Break, % | 454 | 463 | 419 | 441 |

For each of the formulations described in Table 2, the elastomers were first added to the Banbury mixer and processed until the elastomers were softened. Then all the other ingredients were added to the Banbury mixer except the Novolac (W1) and the methylene acceptor block (F1-F3), the vulcanization package and the methylene donor. The materials were mixed until the temperature of the mixture was 90° C. The Novolac (W1) and the methylene acceptor block (F1-F3) were added to the Banbury mixer. Mixing continued until the temperature reached 155° C., at which time the mixture was dropped from the mixer and transferred to a two-roll mill.

The vulcanization package and the methylene donor were added into the mixture on the mill and the productive mix was milled for about seven minutes. The product was then tested for its properties in accordance with the testing procedures described above. For the cured properties, the product was cured for 25 minutes at 150° C.

As may be seen from the physical properties, the processability of the uncured composition was much improved over the witness composition and the physical properties of the cured rubber compositions also showed an improvement overall.

### Example 3

This example illustrates a method for using the methylene acceptor blocks of Example 1 to provide a rubber composition having a high level of organic reinforcing resin and higher levels of carbon black. The formulations were prepared with the component amounts shown in Table 3.

The additives included 6PPD, processing aids and adhesion and vulcanization promoters. The vulcanization package included insoluble sulfur and vulcanization accelerator.

TABLE 3
Hi-Loading Formulations Using the Blocks from Example 1

| Components | W2 | F4 | F5 | F6 |
|---|---|---|---|---|
| NR | 50 | 15.8 | 50 | 50 |
| SBR | 50 | 50 | 15.8 | 40.6 |
| Carbon Black, N326 | 71 | 71 | 71 | 71 |
| Novolac | 17.1 | | | 7.7 |
| Methylene Acceptor Block B1 | | 51.3 | | |
| Methylene Acceptor Block B2 | | | 51.3 | |
| Methylene Acceptor Block B3 | | | | 28.2 |
| Zinc Oxide | 9.4 | 9.4 | 9.4 | |
| Additives | 12 | 12 | 12 | 12 |
| Vulcanization Pkg. | 8.5 | 8.5 | 8.5 | 8.5 |
| Hexamethylenetetramine | 2.35 | 2.35 | 2.35 | 2.35 |

The physical properties of the formulations of Table 3 are provided below in Table 4.

TABLE 4
Physical Properties

| | W2 | F4 | F5 | F6 |
|---|---|---|---|---|
| Uncured Properties | | | | |
| Mooney (1 + 4) at 100° C. | 112.1 | 108.5 | 111.1 | 113.1 |
| Scorch @ 130° C., minutes | 6.3 | 6.0 | 5.9 | 5.9 |
| Processability | Very | Good | Very Good | Very Good |
| | Poor | | | |
| Cured Properties | | | | |
| MA10, MPa | 43.7 | 45.0 | 47.2 | 46.7 |
| P60, % | 36.9 | 37.4 | 38.2 | 37.7 |
| Elongation Stress, MPa | 11 | 12 | 10 | 10 |
| Elongation at Break, % | 143 | 150 | 136 | 134 |

The formulations described in Table 3 were prepared as described in Example 2. As expected, the witness formulation W2 stuck badly to the Banbury mixer but surprisingly, the mixtures prepared by first preparing a methylene acceptor block and then mixing the block into the non-productive mix provided a rubber composition that did not stick to the equipment and was easily processed. Furthermore, it is surprisingly noted that the physical properties of the uncured and cured rubber compositions are significantly improved over the witness.

### Example 4

This example illustrates a method for using the methylene acceptor blocks of Example 1 to provide only half of the methylene acceptor incorporated into a rubber composition, the remaining methylene acceptor being added directly to the mix without first being incorporated in a block. The rubber compositions of this Example do include a high level of the methylene acceptor. The formulations were prepared with the component amounts shown in Table 5.

The additives included 6PPD, processing aids and adhesion and vulcanization promoters. The vulcanization package included insoluble sulfur and vulcanization accelerator.

TABLE 5
Hi-Loading Formulations Partially Using the Blocks from Example 1

| | W2 | F7 | F8 | F9 | F10 |
|---|---|---|---|---|---|
| Components | | | | | |
| NR | 50 | 16 | 33 | 50 | 50 |
| SBR | 50 | 50 | 50 | 16 | 33 |
| Carbon Black, N326 | 71 | 68 | 68 | 68 | 68 |
| Novolac Resin | 17.1 | | 8.5 | | 8.5 |
| Methylene Acceptor Block B1 | | 51 | 25.5 | | |
| Methylene Acceptor Block B2 | | | | 51 | 25.5 |
| Zinc Oxide | 9.4 | 9.4 | 9.4 | 9.4 | 9.4 |
| Additives | 12 | 12.5 | 12.5 | 12.5 | 12.5 |
| Vulcanization Pkg. | 8.5 | 8.5 | 8.5 | 8.5 | 8.5 |
| Hexamethylenetetramine | 2.35 | 3 | 3 | 3 | 3 |
| Uncured Properties | | | | | |
| Processability | Very | Very | Very | Very | Very good |
| | Poor | good | good | good | |
| Cured Properties | | | | | |
| MA10, MPa | 43.7 | 46.8 | 45.1 | 45.4 | 43.8 |
| P60, % | 36.9 | 38.7 | 37.2 | 38.2 | 37.1 |
| Elongation Stress, MPa | 11 | 12 | 13 | 11 | 12 |
| Elongation at Break, % | 143 | 154 | 170 | 153 | 172 |

The formulations described in Table 5 were prepared as described in Example 2. The witness W2 had very poor processability when all 17 phr of methylene acceptor was added to the non-productive mix. However, when 50 wt. % of the Novolac was added through a methylene acceptor block (F8, F10), the processability was vastly improved and the physical characteristics of the resulting cured properties were improved.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention. Ranges that are described as being, “between a and b” are inclusive of the values for “a” and “b.”

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

1. A method for producing a rubber composition for a tire component, the method comprising:
preparing a methylene acceptor block by mixing a first highly unsaturated diene elastomer with a methylene acceptor and cooling the mixture;
mixing a non-productive mix, the non-productive mix comprising a second highly unsaturated diene elastomer, a reinforcing filler and the methylene acceptor block;
cooling the non-productive mix; and then
mixing a vulcanizing agent and a methylene donor into the cooled non-productive mix to produce a productive mix.

2. The method of claim 1, wherein preparing the methylene acceptor block further comprises:
mixing between 30 phr and 200 phr of the methylene acceptor with the first highly unsaturated diene elastomer.

3. The method of claim 1, wherein the methylene acceptor block is free of any reinforcing filler.

4. The method of claim 1, wherein the mixture is cooled at least to a temperature of 35° C.

5. The method of claim 1, wherein the methylene acceptor is selected from a phenol-aldehyde pre-condensate, diphenylolpropane, diphenylolmethane, cresol, resorcinol or combinations thereof.

6. The method of claim 5, wherein the methylene acceptor is a Novolac resin.

7. The method of claim 6, wherein the methylene donor is selected from hexamethylene-tetramine, hexamethoxymethylmelamine or combinations thereof.

8. The method of claim 1, wherein the first and second highly unsaturated diene elastomers are the same.

9. The method of claim 1, wherein the first and second highly unsaturated diene elastomers each contain one or more types of highly unsaturated diene elastomers.

10. The method of claim 9, wherein the one or more types of highly unsaturated diene elastomers are selected from a polybutadiene, a synthetic polyisoprene, a natural rubber, a butadiene-styrene copolymer or combinations thereof.

11. The method of claim 1, wherein mixing a non-productive mix further comprises:
mixing an additional quantity of the methylene acceptor into the non-productive mix, wherein the additional quantity of the methylene acceptor is not premixed into an elastomer mixture.

12. The method of claim 11, wherein the additional quantity of the methylene acceptor is no more than 60 wt. % of the total methylene acceptor in the rubber composition.

13. The method of claim 11, wherein the additional quantity of the methylene acceptor is no more than 50 wt. % of the total methylene acceptor in the rubber composition.

14. The method of claim 11, wherein the methylene acceptor of the additional quantity and of the block are of different types.

15. The method of claim 1, wherein mixing a non-productive mix further comprises:
mixing the second highly unsaturated diene elastomer and the reinforcing filler for a period of time to at least partially disperse the reinforcing filler through the highly unsaturated diene elastomer; and
adding the methylene acceptor block to the at least partially dispersed mix of the reinforcing filler and the highly unsaturated diene elastomer.

16. The method of claim 1, wherein the methylene donor is selected from hexamethylenetetramine, hexamethoxymethylmelamine, formaldehyde or combinations thereof.

17. The method of claim 1, wherein the reinforcing filler is carbon black.

18. The method of claim 17, wherein mixing a non-productive mix further comprises:
mixing between 40 phr and 150 phr of the carbon black into the non-productive mix.

19. The method of claim 1, wherein the rubber composition comprises between 2 phr and 30 phr of the methylene acceptor.

20. The method of claim 19, wherein the rubber composition comprises between 10 phr and 30 phr of the methylene acceptor.

21. The method of claim 1, further comprising:
forming a tire component from the productive mix;
incorporating the tire component into a tire; and curing the tire component.
